(19) United States
(12) Patent Application Publication
(10) Pub. No.: US 2008/0035291 A1
(43) Pub. Date: Feb. 14, 2008

(54) Infrared-Absorbing Ticket Stock and Method of Making Same

(75) Inventors: Harris J. Bacon, Richmond, VA (US); Matthew Meister, DePere, WI (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/459,079

(22) Filed: Jul. 21, 2006

(51) Int. Cl. D21H 11/14; D21H 11/08; D21H 17/28; B42D 15/00

(52) U.S. Cl. 162/147; 162/175; 162/158; 162/162; 162/205; 162/207; 283/53

(57) ABSTRACT

A ticket stock and manufacturing process wherein a pulp is formulated from a blend of recycled printed papers, with added starch for enhancing sheet stiffness and reducing linting and dusting on cut edges of the stock. A preferred pulp comprises a blend of printed solid bleached sulfate plate stock, printed white groundwood-free paper, and printed groundwood paper such as printed newsprint or the like. In one embodiment, the blend comprises about 25-50 wt. % printed solid bleached sulfate plate stock, about 15-40 wt. % printed white groundwood-free paper, and about 15-40 wt. % printed groundwood paper. The printed papers are repulped with minimal mechanical refining, treated with steam injection for hydrating and softening the fibers and breaking up inks into fine particles, and formed into a web that is pressed, dried, and soft calendered. The caliper of the resulting stock is about 7 to 9 points.

### CROSS-REFERENCE TO RELATED APPLICATION

This application is related to U.S. patent application Ser. No. 10/872,139 filed on Jun. 18, 2004, currently pending, the entire disclosure of which is incorporated herein by reference.

### BACKGROUND OF THE INVENTION

The invention relates in general to papermaking, and in particular relates to the manufacture of paper suitable for use as ticket stock used for making redemption tickets of the type commonly dispensed from automated machines in game arcades and the like.

Game arcades often have electronic games that dispense redemption tickets as a reward for having played the game well. Depending on the game score achieved by the player, the game machine dispenses a different number of tickets. The tickets typically can be redeemed for prizes such as toys, stuffed animals, candy, and the like. The game machines generally employ an automated ticket dispenser that dispenses a number of tickets based on the game score. The tickets are supplied in the form of a continuous string of interconnected tickets separated from one another by perforations. The continuous string can be rolled into a roll or folded into a stack for continuous feeding. The tickets usually have a printed bar code on one side and may have other indicia and/or graphics on the opposite side. The edges of each individual ticket are die-cut with a semi-circle notch for pin feeding and ticket counting. The automated ticket dispenser includes an optical sensor that detects the bar code or other printed marking on each ticket, and also senses the die-cut notch. In that manner the dispenser is able to track coded information and count how many tickets are dispensed. Arcades sometimes also include ticket counting machines that operate on a similar principle, such that tickets to be redeemed are fed into the counting machine, which counts the tickets by using an optical sensor.

For proper functioning of the ticket dispensers and ticket counters, and for good aesthetics of the tickets, it is important that the paper or stock making up the tickets have a high opacity so that printed ink on one side of the tickets does not show through to the other side. At the same time, it is desirable for the tickets to have a soft feel in the hand, to have edges that are not so sharp as to pose a risk of cutting the users' hands, to have relatively high strength so they are not easily torn, and to have a highly smooth surface for good printability. Currently available ticket stocks do not always achieve all of these desirable characteristics.

The majority of ticket stocks currently being produced are formed on multi-ply paper machines, and have a thickness or caliper of about 9.5 to 13 points (i.e., 0.0095 to 0.013 inch). Some ticket stock is also produced as a coated solid bleached sulfate (SBS) sheet with a caliper as low as 7 points, but the coating is essential for achieving sufficient opacity to enable proper functioning of the automated ticket dispensers. Such coated SBS ticket stock generally does not have a desirable soft feel in the hand and tends to have sharp edges that can cause paper cuts.

Ticket stock of lower caliper is desirable for improving the ticket yield per unit weight of the papermaking furnish, and for increasing the number of tickets per roll of a given diameter. However, reducing the caliper generally has an adverse impact on some of the other desirable characteristics. For instance, a thinner paper, all other things being equal, has a reduced opacity, a reduced stiffness, and a reduced strength. There is also a certain caliper threshold below which the tickets do not have a good “feel” in the hand, as being too flimsy or insubstantial. It is generally thought that the practical lower limit is about 6.5 to 7 points, as tickets below this caliper level generally feel flimsy and are not favored by consumers.

Additionally, although some ticket stocks are colored, there is a sizeable market for white ticket stock. Such white ticket stock must have a high brightness.

Accordingly, it would be desirable to provide a white ticket stock of relatively low caliper, such as about 7 to 9 points, more preferably about 7 points, having a high opacity, a soft feel, and a highly smooth surface for good printability.

In the original attempt to achieve all of the above objectives as described in the aforementioned '139 application, the stock or furnish used in the manufacture of the paper comprised a mixture of unprinted recycled papers. However, it was later learned that some automated ticket dispensing machines employ an infrared light source to read encoded print on the tickets and to sense ticket cut-outs. The ticket stock produced in accordance with the furnish formulation of the '139 application in some cases was not sufficiently opaque to the infrared light used by such automated dispensers.

### BRIEF SUMMARY OF THE INVENTION

To address this new problem, the present invention seeks to provide the ticket stock with a high level of infrared absorption so the ticket stock is highly opaque to the infrared light used in some automated ticket dispensers. This objective could be achieved with special infrared absorbents added to the paper furnish, but such absorbents are expensive and also are not readily retained in the wet-formed sheet.

However, it was discovered that some components of conventional inks used in the printing industry provide a high level of IR absorption. Accordingly, the ticket stocks in accordance with the invention are made from printed recycled papers. The papers used in the pulp are printed with inks that contain infrared-absorbing components that remain in the web so as to enhance infrared absorption of the ticket stock.

Thus, the present invention employs a furnish comprising a blend of recycled printed paper grades. The furnish in one embodiment comprises a blend of printed solid bleached sulfate (SBS) plate stock, printed white groundwood-free paper such as manifold white ledger (MWL), and printed groundwood furnish such as over-issue news (OIN). The furnish can include added starch for enhancing sheet stiffness and reducing linting and dusting on cut edges of the stock. Generally, the furnish does not require added clay or other opacifier for enhancing opacity of the stock, although the furnish optionally could include such an opacifier. In one embodiment, the blend comprises about 25-50 wt. % recycled printed SBS plate stock, about 15-40 wt. % printed MWL, and about 15-40 wt. % OIN. A blend in particular can comprise about 40% printed SBS plate stock, about 30% printed MWL, and about 30% OIN. Starch can be added in the amount of about 25 to 35 pounds per ton of the finished stock.

The ticket stock preferably has a caliper of about 7 to 9 points, more preferably about 7 points. The ticket stock has a Parker Smoothness not substantially exceeding about 8 microns, more preferably not substantially exceeding about 6 microns, and still more preferably not substantially exceeding about 5 microns.

A process for making a ticket stock in accordance with the invention entails formulating a pulp from a mixture of recycled papers including printed papers as noted above, and adding starch and clay or other opacifier to the pulp. The recycled papers are repulped with minimal mechanical refining or fiber shortening. The pulp is then processed at elevated temperature to hydrate and soften the fibers; this can be accomplished, for example, in a unit that injects steam into the pulp while the pulp is at a high consistency. This treatment is also effective to break up the ink of the printed papers into very fine particles.

Next, the pulp is fed at a suitable consistency level to a former, which forms a wet web. The former can comprise any of various formers known in the art, including single-ply and multi-ply formers. In one embodiment, a fourdrinier former is employed to form a single-ply web.

The wet web is then dewatered and pressed in a press section. The press section can comprise various types and numbers of presses. In one embodiment, the press section comprises two sequentially arranged presses such as roll presses equipped with dewatering fabrics. The web is then advanced through a drying section. The drying section can be of various configurations. In one embodiment of the invention, the drying section comprises a series of heated drying cylinders that the web is brought into contact with in turn. The web can be urged into firm contact with the cylinders by fabrics.

After drying, the web is fed through a soft nip calender. The calendering of the web imparts a smooth surface to the web for good printability and enhances the soft feel of the web. The process is carried out in such a manner that the infrared-absorbing components of the inks remain in the finished web and thereby enhance the infrared absorption of the web.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic depiction of a papermaking machine and process in accordance with one embodiment of the invention;

FIG. 2 is a schematic illustration of one cylinder group of the drying section in accordance with one embodiment of the invention; and

FIG. 3 shows a roll of redemption tickets formed of a stock in accordance with an embodiment of the invention.

### DETAILED DESCRIPTION OF THE INVENTION

The present inventions now will be described more fully hereinafter with reference to the accompanying drawings, in which some but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

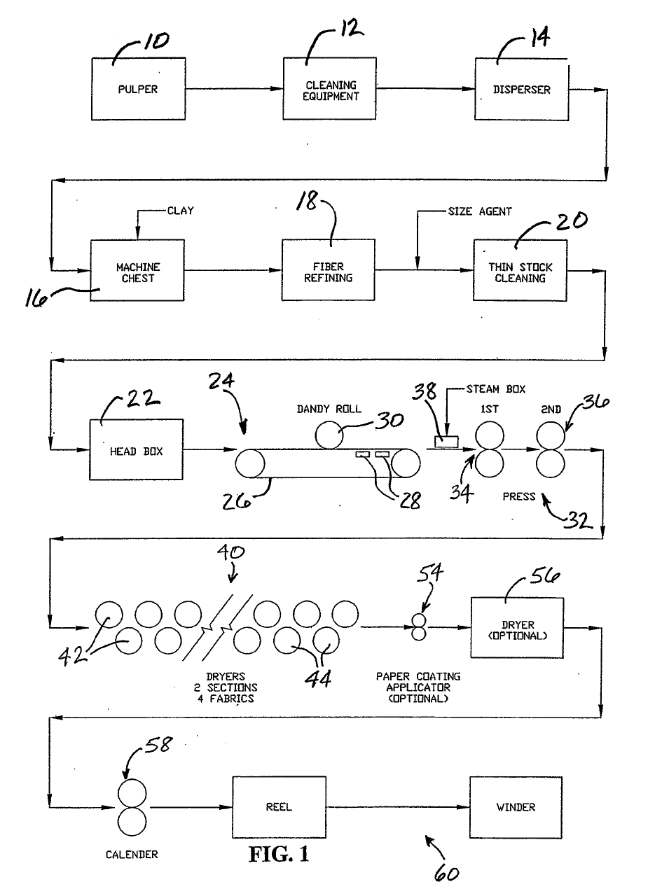

With reference to FIG. 1, an apparatus and process for making a paper suitable for use as a ticket stock is illustrated. The process begins by placing a mixture of papers into a pulper, or repulper, 10 along with a quantity of water and agitating the mixture to break the papers down into a pulp. The mixture of papers comprises a blend of recycled papers that include printed papers. A preferred mixture comprises a blend of printed solid bleached sulfate (SBS) plate stock, printed manifold white ledger (MWL), and printed groundwood paper such as over-issue news (OIN). Throughout the present application, recycled paper designations (e.g., SBS, MWL, OIN, etc.) are used in accordance with the Paper Stock Standards PS-93 published by the Institute of Scrap Recycling Industries.

The printed papers used in the pulp are printed with inks that contain IR-absorbing components. In preferred embodiments of the invention, the inks include “infrared-active” compounds that are efficient at absorbing IR radiation in the near-infrared (NIR) wavelength range of about 700 to 1100 nm. Such infrared-active compounds include but are not limited to metalloporphyrins, porphyrin ligands, and quinoids. Many inks and dyes used in recycled paper grades such as printed ledger, printed bleached board, and newsprint have such compounds. These compounds are so efficient at absorbing IR radiation that even though there may be a low concentration of the compounds in the ticket stock, it is sufficient to absorb enough IR radiation in the NIR range to provide adequate IR opacity for proper functioning of automated ticket dispensers and counters whose sensor systems operate in the NIR range.

In one embodiment, the blend comprises about 25-50 wt. % printed SBS plate stock, about 15-40 wt. % printed MWL, and about 15-40 wt. % OIN. A particularly advantageous blend comprises about 40 wt. % printed SBS plate stock, about 30 wt. % printed MWL, and about 30 wt % OIN. The papers advantageously are printed, but some proportion of unprinted paper could be used as long as a substantial proportion of printed paper is included in the pulp. The pulp can include added starch for enhancing sheet stiffness and reducing linting and dusting on cut edges of the stock. For example, about 25 to 35 pounds per ton (based on dry weight of the pulp) of starch can be added to the pulp. The starch can comprise potato starch or the like.

The pulp preferably is free of UV-curable polymers such as UV-cured inks or coatings that are present in some recycled paper grades. Such UV-curable polymers are extremely difficult to break down into fine particle sizes in a paper pulp slurry. The recycled papers used in the pulp preferably are also free of polymer coatings such as polyethylene or polypropylene coatings, because these types of coatings are also very difficult to disperse into fine particles.

The pulper 10 preferably repulps the papers without any substantial degree of mechanical refining or fiber shortening. In this regard, the pulper preferably comprises a large open metal vessel with a high shear agitator in the bottom. A slurry of pulp at a consistency of 4%-6% solids is formed by feeding dry paper bales along with process white water into the pulper and agitating until the slurry can be extracted through a perforated plate and pumped to a receiving chest for further processing.

After the papers are pulped in the pulper 10, the resulting pulp is cleaned using suitable cleaning equipment 12 to remove certain undesirable contaminants such as plastic, metal, glass, wood splinters, and dirt. The cleaning equipment comprises liquid cyclone cleaners that continuously remove particles of high specific gravity and contaminant materials such as sand, glass, paper clips, and staples, and also includes barrier screens that are designed to continuously remove oversized particles from the pulp stream prior to refining and formation.

The pulp is then fed into a disperser 14 that injects steam into the pulp while the pulp is at a high consistency (e.g., approximately 12%-20%). The disperser is a horizontally oriented, pressurized cylindrical vessel with a screw type feeder designed to keep slurry moving continuously through the vessel. The injected steam softens and hydrates the fibers of the pulp. Additionally, the steam injection breaks the inks down into very small particles that remain in the finished paper but can barely be seen with the naked eye. Pigment in the form of high-brightness clay can be added later in the process to offset the loss of brightness caused by the presence of ink, if desired.

The pulp is fed from the disperser into a machine chest 16 where additional water is added to the pulp to reduce the consistency to a level suitable for paper forming. Additionally, one or more additives can be added to the pulp at this stage. For example, optionally an amount of clay, liquid opacifier, or other opacifying agent can be added to the machine chest 16 for enhancing the opacity of the finished paper. In preferred embodiments of the invention, however, the pulp is free of any added opacifying agent.

Next, a process of fiber refining 18 can be performed using suitable equipment such as fractionating units or the like, to achieve a pulp having fiber lengths in a desired range. Such fractionating units and processes are known in the art and hence need not be described in detail herein. Advantageously, the pulp after the refining step 18 has developed sufficient bonding sites on the fiber cell walls for strength development with minimum fiber length reduction. Following the refining step, a size agent such as starch can be added to the pulp as shown. Starch can be added in the amount of about 25 to 35 pounds per ton of the finished stock.

The pulp advantageously is then subjected to a thin stock cleaning process 20. This process consists of pumping dilute slurry (<1% solids) through a bank of multiple high velocity centrifugal cleaners to remove a large percentage of remaining fine particle contaminant materials (approx. 70%-90% removal rate).

The pulp is then fed into a headbox 22 of a fourdrinier former 24. The headbox injects a stream of pulp onto a traveling wire 26 of the former. Dewatering elements 28 beneath the wire drain some of the water from the web formed on the wire. Advantageously, a Dandy roll 30 (i.e., essentially a roll with a wire screen wrapped about it) contacts the upper surface of the formed web to assist in web formation.

The web formed in the fourdrinier former 24 is advanced to a press section 32 for further dewatering. The press section can comprise various types and numbers of press devices, including roll presses, extended-nip or shoe presses, or the like. In the illustrated embodiment, the press section comprises a first roll press 34 and a second roll press 36. Each of the roll presses includes a pair of dewatering fabrics (not shown) between which the wet web is sandwiched. The fabrics with the web therebetween are passed through the nip between the two rolls of the press. The pressure exerted on the fabrics and web causes water to be transferred from the web into the fabrics, as known in the art. The linear nip load exerted on the fabrics and web is generally higher in the second press 36 than in the first press 34. For example, the nip load in the first press advantageously can be about 400 lb/linear inch (PLI) while the load in the second press can be about 1400 PLI.

The web can be treated by a steam box 38 prior to the press section 32 in order to heat the wet sheet and improve pressing and drying efficiency.

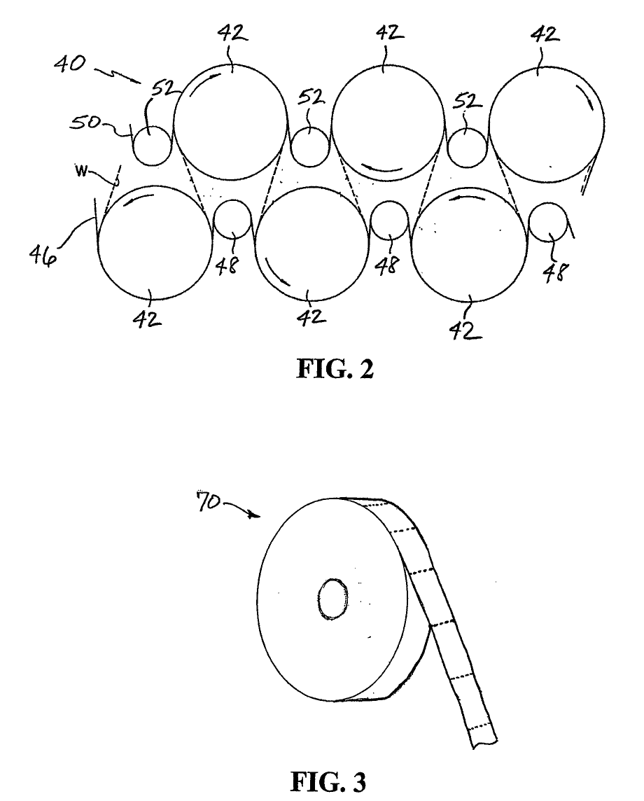

After pressing, the web is fed through a dryer section 40 for thermally drying the web to a desired low moisture content. The dryer section is made up of a first group of heated drying cylinders 42 and a second group of heated drying cylinders 44. Each group of cylinders includes a pair of fabrics for urging the web against the cylinders. FIG. 2 shows the first group of cylinders 42 in greater detail. The cylinders are arranged so that the web W passes in serpentine fashion about each cylinder in turn, whereby one side of the web contacts the first cylinder, the other side of the web contacts the next cylinder, and this alternate cycle repeats for the next two cylinders, etc. A first fabric 46 is arranged to pass around a first set of the cylinders 42. Guide rolls 48 guide the first fabric 46 from one cylinder to the next and allow the fabric to wrap about a substantial proportion of the circumference of each cylinder. The web W is arranged so that it is between the first fabric 46 and each cylinder 42. A second fabric 50 is arranged to pass around a second set of the cylinders 42, and guide rolls 52 guide the second fabric from one cylinder to the next and allow the fabric to wrap about a substantial proportion of the cylinder circumferences.

The second group of drying cylinders 44 likewise has a pair of fabrics that operate in the way described above.

With reference again to FIG. 1, after the web exits the drying section 40, it can optionally be coated on one or both sides in a coating applicator 54. The applied coating(s) can then be dried in a dryer 56. Advantageously, however, a ticket stock in accordance with preferred embodiments of the invention does not have any coating.

Next, the web is passed through a calender 58. The calender advantageously comprises a soft nip calender wherein one of the calender rolls has a surface that is deformable so that the nip formed between the deformable roll and the opposing roll is somewhat elongated rather than being a single tangent point between two rigid rolls. The calender is preferably heated. A suitable calendering temperature is between about 400° F. and about 500° F. Calendering of the web in the soft nip calender imparts a smooth surface to the web for good printability, and enhances the soft feel of the web.

Finally, the finished web is wound into a roll in a reel-up 60. The roll of finished stock typically is shipped to a converter where it is converted into redemption tickets or other products. In the case of redemption tickets, the stock is unwound from the roll, slit, perforated, and printed to form a continuous string of interconnected tickets. The string can be wound into individual rolls of redemption tickets such as the roll 70 shown in FIG. 3. Alternatively, the string of tickets can be folded into a stack or bundle for loading into an automatic dispenser.

The stock in accordance with preferred embodiments of the invention is manufactured to have a caliper of about 7 to 9 points, more preferably about 7 points. The stock preferably has a basis weight of about 30 to 31 lb/1000 ft². The stock preferably has a Parker Smoothness, on at least one of its surfaces, not substantially exceeding about 8 microns, more preferably not substantially exceeding about 6 microns, and still more preferably not substantially exceeding about 5 microns.

A plurality of different ticket stocks of nominally the same calipers were produced as hand-made sheets from different pulp formulations, some formed from unprinted papers and others formed from printed papers. Two unprinted formulations were made, and four printed formulations were made. All six formulations contained 30% by weight news (i.e., groundwood paper), but differed in percentages of the other components. The stocks all had a nominal caliper of about 15 points and a nominal basis weight of about 31 lb/1000 ft². Although the caliper of the hand-made sheets was much higher than the desired 7-point caliper for ticket stock made in a paper-making machine in which the stock is calendered to reduce its caliper, the more significant parameter in terms of infrared absorption is the basis weight, which indicates how much paper mass must be penetrated by the infrared light in order to pass completely through the stock.

The resulting six different ticket stocks were tested for infrared opacity using components from an automated ticket dispenser available from Deltronics, Inc. The ticket dispenser uses an infrared light source for detecting printing and cutouts on tickets being dispensed. The infrared light had a wavelength of 940 nm. An infrared sensor was positioned on the opposite side of the ticket stock from the light source for detecting infrared light passing through the ticket stock. The sensor's output voltage varied inversely with the amount of light passing through the ticket stock. Thus, a higher voltage indicated higher absorption of the infrared light, and thus higher opacity to the infrared light. Multiple specimens of each ticket stock were tested and the voltage readings were averaged. The ticket stocks were also tested for Minolta color (average of front and back sides) and their calipers were measured.

The compositions of the six different pulp formulations and the test results are given in the following table:

| | Ticket Stock No. | | | | | |
|---|---|---|---|---|---|---|
| Pulp Component | 1 | 2 | 3 | 4 | 5 | 6 |
| No. 2 Unprinted SBS Plate Stock | 20 | 40 | | | | |
| Unprinted Coated Soft White | 50 | 30 | | | | |
| Blank News | 30 | 30 | | | | |
| Printed SBS Plate Stock | | | 20 | 20 | 40 | 30 |
| Printed Coated Book | | | 50 | | 30 | |
| Printed Manifold White | | | | 50 | | 40 |
| Over-Issue News | | | 30 | 30 | 30 | 30 |
| Caliper | 15.89 | 14.73 | 14.21 | 14.64 | 15.61 | 15.3 |
| Color L | 89.32 | 89.33 | 77.49 | 78.57 | 80.03 | 80.26 |
| a | −0.61 | −0.81 | −1.16 | −0.68 | −0.63 | −0.87 |
| b | 4.11 | 4.92 | 3.37 | 3.21 | 3.63 | 4.08 |
| Average Volts (IR Opacity) | 8.9 | 8.9 | 11.3 | 11.2 | 11.0 | 11.2 |
| Voltage Range | 8.6–9.0 | 8.6–9.2 | 11.1–11.5 | 10.9–11.4 | 10.7–11.3 | 10.8–11.5 |

It can be seen that the opacity to infrared light, as indicated by the volts of the sensor's output signal, was a strong function of the printed versus unprinted formulation. The ticket stocks made from the unprinted formulations were deemed unacceptable in opacity to the infrared light. All of the ticket stocks made from the printed formulations, however, exceeded the minimum acceptable voltage of 10 volts that was established for proper functioning of typical automated ticket dispensers.

It was thus confirmed that some of the components of conventional inks used in the printing industry provide a high level of infrared absorption. Accordingly, the ticket stocks made from printed recycled paper grades contain such components and thus have sufficient opacity to the infrared light used in typical automated ticket dispensers to allow the dispensers to function properly. In contrast, ticket stocks made from unprinted recycled paper grades lack the IR-absorbing components and thus fail to achieve adequate opacity to the infrared light.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A recycled paper product, comprising:
a web formed from a pulp comprising printed recycled papers including printed solid bleached sulfate plate stock, printed white groundwood-free paper, and printed groundwood paper, the pulp further comprising starch for enhanced stiffness and reduction of linting and dusting on cut edges of the paper product, the paper product having a caliper of about 7 to 9 points, the printed recycled papers being printed with inks that contain infrared-absorbing components that remain in the web so as to enhance infrared absorption of the recycled paper product.

2. The recycled paper product of claim 1, wherein the pulp comprises about 25-50 wt. % printed solid bleached sulfate plate stock, about 15-40 wt. % printed white groundwood-free paper, and about 15-40 wt. % printed groundwood paper.

3. The recycled paper product of claim 1, wherein the printed groundwood paper comprises printed newsprint.

4. The recycled paper product of claim 1, wherein the starch comprises about 25-35 lb/ton of the pulp.

5. The recycled paper product of claim 1, wherein the paper product comprises a single ply.

6. The paper product of claim 1, wherein the pulp is free of UV-curable polymers.

7. The paper product of claim 1, wherein the printed recycled papers used in the pulp are printed with substances containing one or more of metalloporphyrin, porphyrin ligand, and quinoid compounds.

8. A process for making a paper product, comprising the steps of:
(a) repulping a mixture of printed recycled papers to produce a pulp, the printed recycled papers being printed with inks that contain infrared-absorbing components;
(b) adding starch to the pulp;
(c) hydrating and softening the fibers of the pulp under elevated temperature conditions;
(d) forming a wet web out of the pulp from step (c);
(e) dewatering and pressing the wet web in a press section;
(f) drying the web on a series of heated drying cylinders; and
(g) soft-nip calendering the dried web;
wherein the process is carried out such that the infrared-absorbing components of the inks remain in the dried web so as to enhance infrared absorption of the paper product.

9. The process of claim 8, wherein step (a) comprises repulping a mixture including printed solid bleached sulfate plate stock, printed white groundwood-free paper, and printed groundwood furnish.

10. The process of claim 9, comprising repulping a mixture of about 25-50 wt. % printed solid bleached sulfate plate stock, about 15-40 wt. % printed white groundwood-free paper, and about 15-40 wt. % printed groundwood furnish.

11. The process of claim 8, wherein step (d) comprises forming the wet web using a fourdrinier former.

12. The process of claim 8, wherein step (e) comprising dewatering and pressing the wet web in a pair of sequentially arranged presses.

13. The process of claim 8, further comprising the step of treating the web with a steam box between steps (f) and (g).

14. The process of claim 8, wherein step (f) comprises using fabrics to urge the web against the heated drying cylinders.

15. The process of claim 8, wherein step (b) comprises adding starch in the amount of about 25-35 lb/ton of the pulp.

16. A process for making a white ticket stock, comprising the steps of:
(a) repulping, with minimal mechanical refining or fiber shortening, a mixture of printed recycled papers to produce a pulp, the printed recycled papers being printed with inks that contain infrared-absorbing components;
(b) adding starch to the pulp;
(c) hydrating and softening the fibers of the pulp under elevated temperature conditions;
(d) forming a wet web out of the pulp from step (c);
(e) dewatering and pressing the wet web in a press section;
(f) drying the web on a series of heated drying cylinders; and
(g) soft-nip calendering the dried web;
wherein the process is carried out such that the infrared-absorbing components of the inks remain in the dried web so as to enhance infrared absorption of the paper product.

17. The process of claim 16, wherein step (a) comprises repulping a mixture of printed solid bleached sulfate plate stock, printed white groundwood-free paper, and printed groundwood furnish.

18. The process of claim 17, wherein step (c) comprises processing the pulp in a hot dispersion unit.

19. The process of claim 18, wherein the pulp has a relatively high consistency during step (c), and further comprising the step of reducing the consistency of the pulp after step (c) but before step (d).

20. The process of claim 16, wherein step (d) comprises forming a single-ply web.

21. The process of claim 16, further comprising the step of treating the web with a steam box between steps (f) and (g).

22. The process of claim 16, wherein step (f) comprises using fabrics to urge the web against the heated drying cylinders.

23. A string of redemption tickets formed as an elongate strip of ticket stock having perforations to define a series of interconnected redemption tickets, the ticket stock comprising a fibrous web formed from a pulp comprising a mixture of printed recycled papers including printed solid bleached sulfate plate stock, printed white groundwood-free paper, and printed groundwood paper, and further comprising starch for reduction of linting and dusting on cut edges of the redemption tickets, the redemption tickets having a caliper of about 7 to 9 points, the printed recycled papers being printed with inks that contain infrared-absorbing components that remain in the ticket stock so as to enhance infrared absorption of the redemption tickets.
